(19) United States
(12) Patent Application Publication
(10) Pub. No.: US 2015/0107119 A1
(43) Pub. Date: Apr. 23, 2015

(54) CUTTER FOR WOVEN BELT

(71) Applicant: Hsiu-Man Yu Chen, TAICHUNG CITY (TW)

(72) Inventor: Hsiu-Man Yu Chen, TAICHUNG CITY (TW)

(21) Appl. No.: 14/587,970

(22) Filed: Dec. 31, 2014

Related U.S. Application Data
(63) Continuation-in-part of application No. 13/181,642, filed on Jul. 13, 2011.

(51) Int. Cl. B26B 25/00

(52) U.S. Cl. CPC B26B 25/007
USPC 30/283

(57) ABSTRACT

A cutter for woven belt includes a handle having two ends respectively defined to be a first end and a second end. The handle has a circumferential side provided with a cutting opening located close to the first end, extended in a direction from the second end toward the first end and having an opposite sealed end connected with two guide grooves. A blade assembled within the handle and stored in an accommodating chamber, has a second insert bore corresponding to a first bore of an accommodating chamber. The blade comprises a circumference edge with a series of mark labeled thereon and protrudes into the cutting opening of the handle. The cutter also comprises a fixing plate cover to shield the accommodating chamber wherein the blade is stored. The handle also comprises a positioning member to fix the blade and also the easily for changing a blade.

This application is a continuation-in-part of U.S. patent application Ser. No. 13/181,642 filed on Jul. 13, 2011.

### BACKGROUND OF THE INVENTION

1. Field of the Invention

The present invention relates to a cutter for woven belt.

2. Brief Description of the Prior Art

Woven belt has been frequently used for wrapping transported goods to prevent the contained stuff from being collided with one another. Also, the package with a woven belt wrapped outside of the same will not fall apart during the course of transportation. When the package reached its destination and the content will be taken out from the package, it is usually to use a cutter to cut the woven belt to open the package. A conventional cutter is best described with reference to FIG. 1. The cutter 100 for woven belt comprises a handle 401 having two ends respectively defined to be a first end 402 and a second end 403. Adjacent to the first end 402, there is another end 405 to form a cutting opening 404 which extends all the way till the sealed end 406. The handle 401 of the cutter 400 has a slot inside the handle 401 containing a blade 407 stored inside the slot with the edge of the blade 408 protruding into the cutting opening 404.

When the woven belt is to be cut, as shown in FIG. 2, user will hold the cutter handle 401 and keep the cutting opening 404 aligned to a woven belt 200 and then push the cutter 400 toward the woven belt 200 so as to have the same being cut by the blade 407.

However, since the woven belt 200 is usually made of soft cloth or the like, and the cutting opening 404 of the cutter 400 is formed in a direction from the first end 402 toward the second end 403 with the width of the woven belt 200 being longer than the entire depth of the cutting opening 404, therefore, during the course of cutting off the woven belt 200 which may be only portion of the woven belt 200 being cut part. Particularly, the cut portion will be accumulated toward the sealed end 406 of the cutting opening 404. This will become an obstacle to prevent the normal cutting operation from smoothly made. Sometimes the user's hand will be hindered to cut the woven belt. As a result, the conventional cutter 400 fails to cut off the woven belt 200 effectively and completely.

### SUMMARY OF THE INVENTION

The principle object of present invention is to provide a cutter for woven belt capable of effectively cut off woven belt wrapped on the package so as to facilitate the sequent work of removing woven belt from the package of goods.

The principle feature of the cutter for woven belt according to the present invention is to provide a cutter comprising a handle with an accommodating chamber is formed therein for storing a blade.

Another object and feature of the present invention is to provide a cutter for woven belt having a fixing plate cover to handle.

Another object and feature of the present invention is to provide a cutter for woven belt having respective bores on accommodating chamber, blade and fixing plate cover. The fixing member will pass through those bores to assemble the entire cutter.

Another object and feature of the present invention is to provide a cutter for woven belt which has a positioning member on the blade so that the blade can be properly stored in the accommodating chamber and accurately with its blade edge protruding into the cutting slot of the handle.

The cutter for woven belt in the present invention includes a handle and a blade as main components combined together. The handle has two ends respectively defined to be a first end a second end and has a circumferential side provided with a cutting opening that is located close to the first end, extended in a direction from the second end toward the first end and formed with an open end and an opposite sealed end. Further, the handle has two sides respectively disposed with a guide groove at a location adjacent to the first end, and each guide groove has one end connected with the sealed end of the cutting opening and another end formed with a guide slope slanting outward lengthwise along the cutting opening. The blade is assembled with the handle, abutting against the cutting opening and having its circumferential side provided with a blade edge that is exposed in the cutting opening.

Since the cutting opening of the cutter of this invention is provided in a direction from the second end toward the first end; therefore, in a cutting process, a user's hand is moved in a direction distant from the woven belt, able to prevent the woven belt that is cut apart from hindered by the user's hand. In addition, after cut apart, the cut portion of the woven belt can be guided by the guide slopes of the guide grooves to be separated from the original woven belt, able to prevent the woven belt cut apart from being accumulated at the sealed end of the cutting opening. By so designing, the cutter of this invention can effectively cut off woven belts to facilitate the subsequent work of removing woven belt from package.

### BRIEF DESCRIPTION OF DRAWINGS

The present invention will be better understood by the detailed description of the preferred embodiments with reference to the accompanying drawings, wherein:

FIG. 1 is a perspective view of a conventional cutter for woven belt;

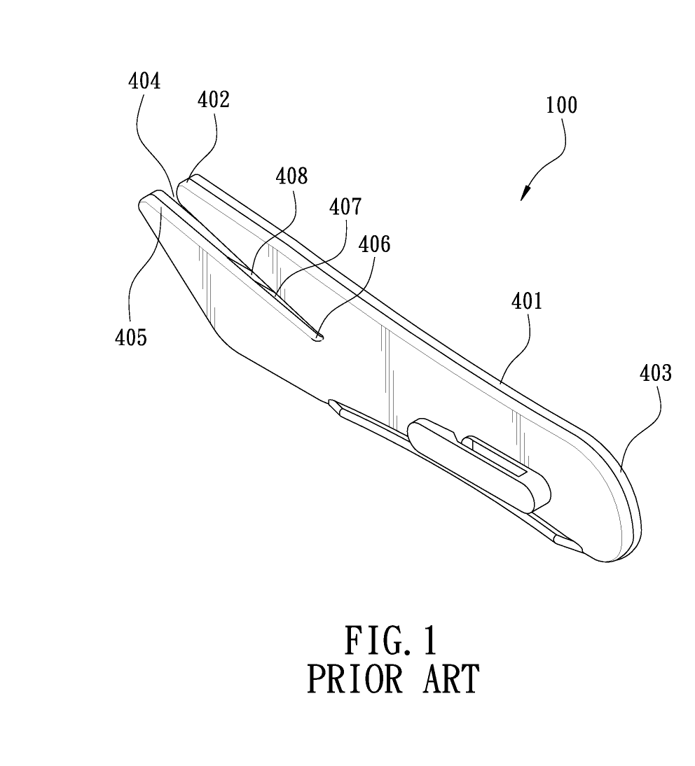

FIG. 2 is an illustrative schematic view of the conventional cutter for woven belt during operation;

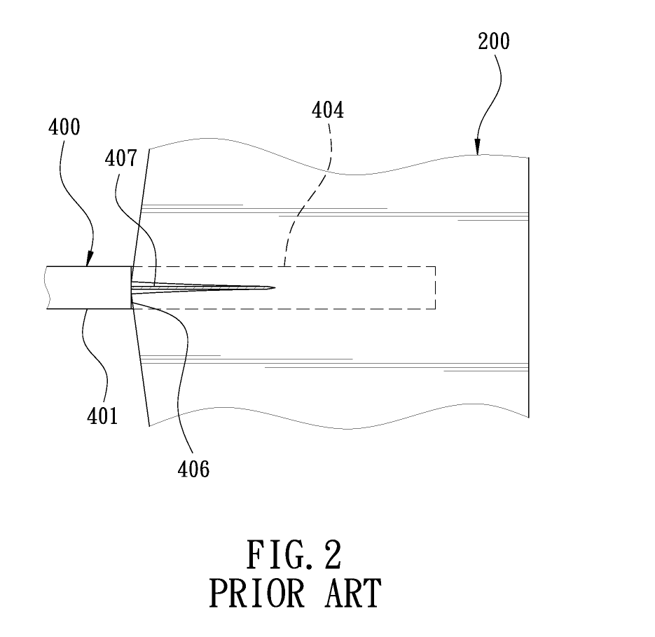

FIG. 3 is a perspective view of a cutter for woven belt according to the present invention;

FIG. 4 is an exploded perspective view of the cutter for woven belt according to the present invention;

FIG. 5 is a vertical sectional side view of the cutter for woven belt according to the present invention with portion cut away;

FIG. 6 is a side of the cutter for woven belt according to the present invention with the blade moved away;

FIG. 7 is a sectional view of the cutter for woven belt according to the present invention along the line A-A in FIG. 5;

FIG. 8 is a sectional view of the cutter for woven belt according to the present invention along the line B-B in FIG. 5.

FIG. 9 is a schematic view of the cutter according to the present invention showing that a woven belt to be cut by the cutter;

FIG. 10 is a schematic view of the cutter according to the present invention illustrating the cut portion of the woven belt being guided to be separated by the guide groove;

FIG. 11 is a schematic view of the cutter according to the present invention being used to unseal a package;

FIG. 12 is a sectional view of the cutter according to the present invention showing the blade being rotated for an angle to shift the same to a better cut portion of the blade; and

FIG. 13 is an illustrative side view of the cutter for woven belt according to the present invention showing the status of change a blade of the cutter.

### DETAILED DESCRIPTION OF THE PREFERRED EMBODIMENT

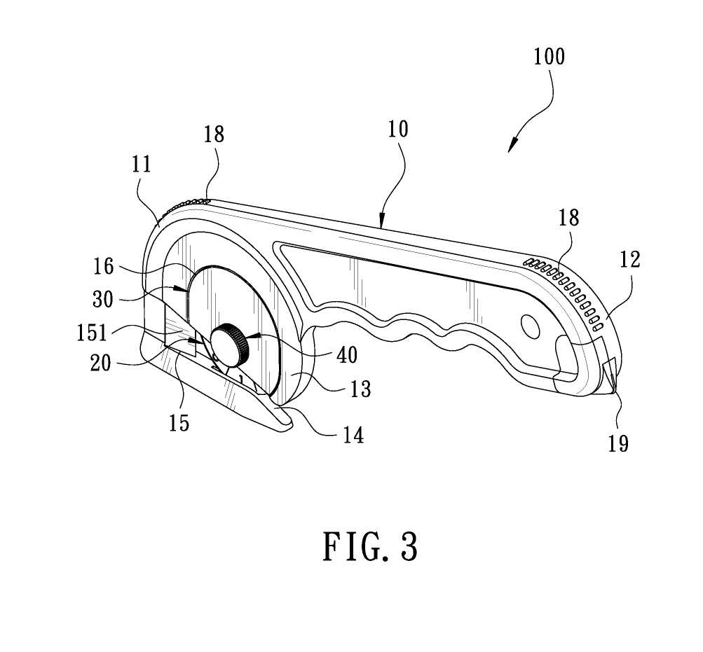

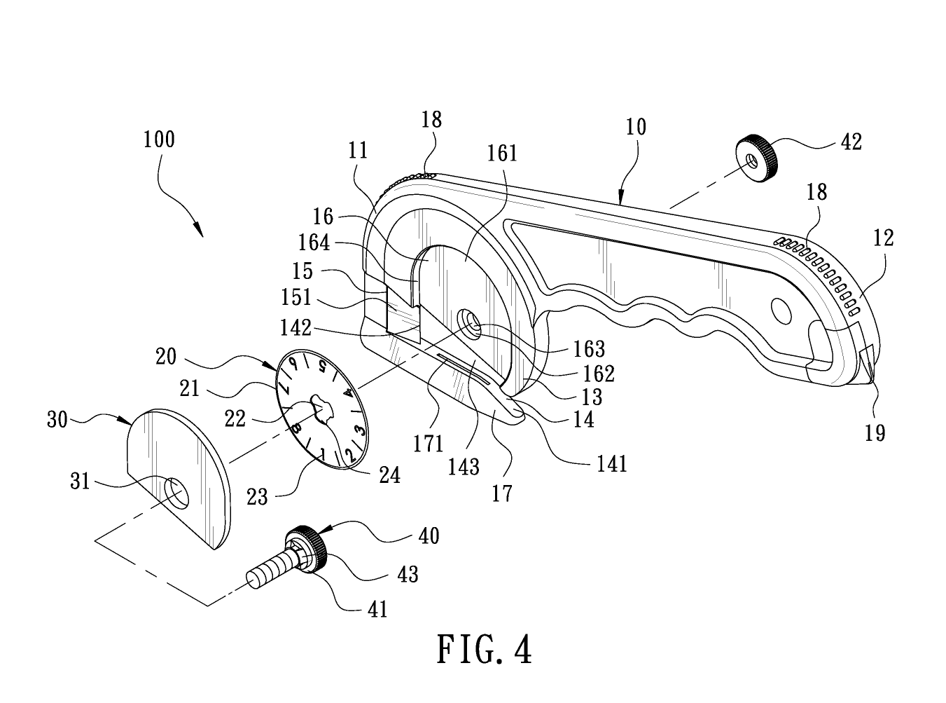

Referring to FIGS. 3, 4 and 5, a preferred embodiment of a cutter for woven belt in the present invention includes a handle 10, a blade 20, a fixing plate cover 30 and a fixing member 40 as main components combined together.

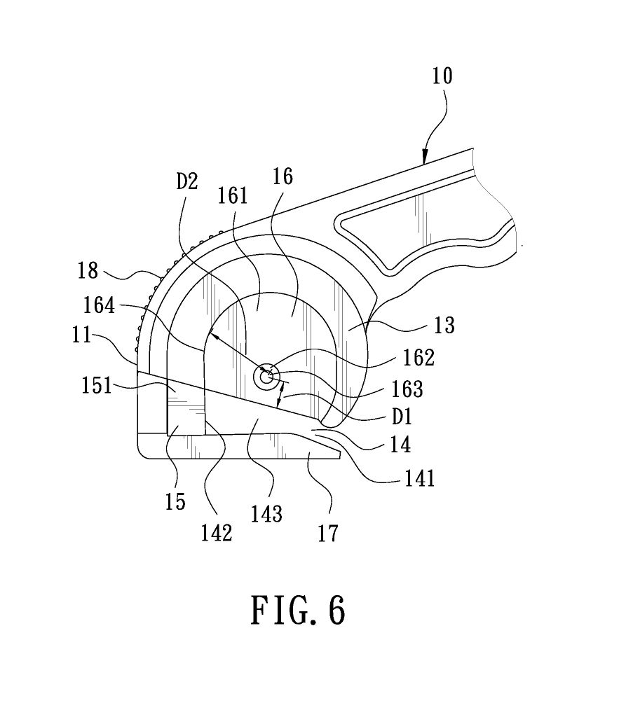

The handle 10 has two ends respectively defined to be a first end 11 and a second end 12, and a cutting portion 13 is extended transversely from the first end 11. The handle 10 further has a circumferential side bored with a cutting opening 14 at a location adjacent to the first end 11. In this preferred embodiment, the cutting opening 14 is disposed in the cutting portion 13, extended in a direction from the second end 12 toward the first end 11 and formed with an open end 141 and an opposite sealed end 142. There is formed a cutting slot 143 formed. Furthermore, the handle 10 has two sides respectively cut with a guide groove 15 located close to the first end 11. In this preferred embodiment, the two guide grooves 15 are respectively positioned at the two sides of the cutting portion 13 respectively having one end connected with the sealed end 142 of the cutting opening 14 and another end formed with a guide slope 151 extending and slanting outward lengthwise along the cutting opening 14 and connected with the circumferential side of the cutting portion 13 as shown in FIG. 6.

In addition and also referring to FIG. 6, the cutting portion 13 is provided with an accommodating chamber 16 communicating with the cutting opening 14 and bored with a first bore 163 near the bottom. The distance between the first bore 163 and the cutting slot 143 is defined as a first distance D1. The distance between the first bore 163 and the chamber wall 164 of the accommodating chamber 16 is defined as a second distance D2. In the embodiment, the first distance D1 is less than the second distance D2. The chamber wall 164 of the accommodating chamber 16 is elliptical. Also in the handle 10, there is a base 17 provided at the opposite side of the cutting slot 143. The base 17 has slot 171 parallel to the surface of the chamber bottom 161 of the accommodating chamber 16.

On the surface of the circumferential side close to the first end 11, there is provided thereon with a plurality of anti-skid bumps 18 and another circumferential side close to the second end 12 set thereon with a plurality of anti-skid projection 18 and a protruding member 19.

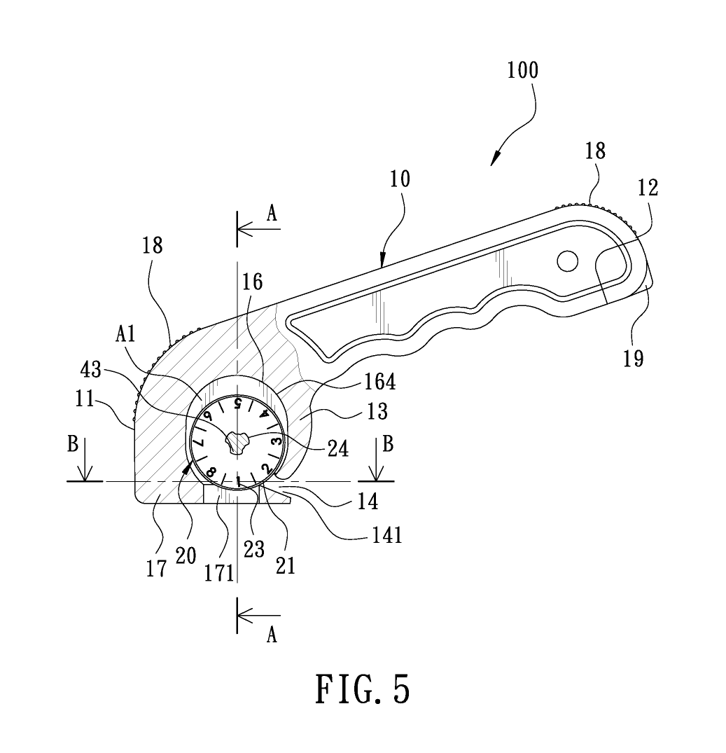

A blade 20 is assembled within the handle 10 at a location abutting against the cutting opening 14 and has its circumferential side provided with a blade edge 21. The blade 20 is a flat metal blade substantially in the elliptical shape. In this preferred embodiment, the blade 20 is stored in the accommodating chamber 16 of the cutting portion 13. The blade 20 has a second bore 22 which is larger in diameter than the same of the first bore 163 but less than the same of the recess 162. There is a second insert hole 22. The blade 20 also comprises a positioning member 24 which are a plurality of notches along the second insert bore 22. A portion of the blade 22 is protruding into the cutting opening 14. A rest portion of the blade 20 is protruded into the slot 171. The blade 20 is adjacent to the chamber wall 164 of the accommodating chamber 16 with a gap A1 as shown in FIG. 5. On one surface of the blade 20, there are provided a series of marks 23, in calibration curved lines, along the outer peripheral edges of the blade 20 also as shown in FIG. 5.

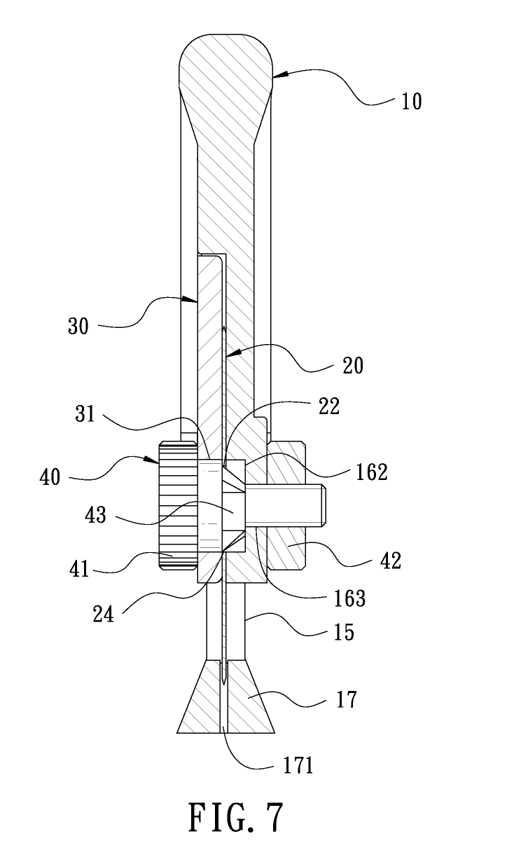

A fixing plate cover 30 is to be fixed in the accommodating chamber 16 and positioned at the outer side of the blade 20 for restrictedly positioning the blade 20 in the accommodating chamber 16. The fixing plate cover 30 is bored with a third insert bore 31 corresponding with the first insert bore 163 of the accommodating chamber 16. It is shown in FIG. 7, the dimension of the third insert bore 31 is larger than the same of the first bore 163 and the second insert bore 22. The dimension of the third insert bore 31 is equal to the same of the recess 162 so that the entire blade 20 can be installed in the cutting portion 13 of the accommodating chamber 16.

A fixing member 40 comprises a bolt 41 to be inserted through the first bore 163, the second insert bore 22 and the third insert bore 31, and a nut 42 to be secured at the end of the bolt 41 for combining the fixing plate cover 30 together with the blade 20 and handle 10. In the present embodiment, the fixing member 40 has an adjusting member 43 formed on the bolt 41 which will be cooperated with the positioning member 24 of the blade 20 so that the fixing member 40 can be rotated along with the blade 20. The adjusting member 43 on the bolt 41 comprises a plurality of protrusions to cooperate with the positioning member 24 while the fixing member 40 is fixed with the bolt 41 and nut 42.

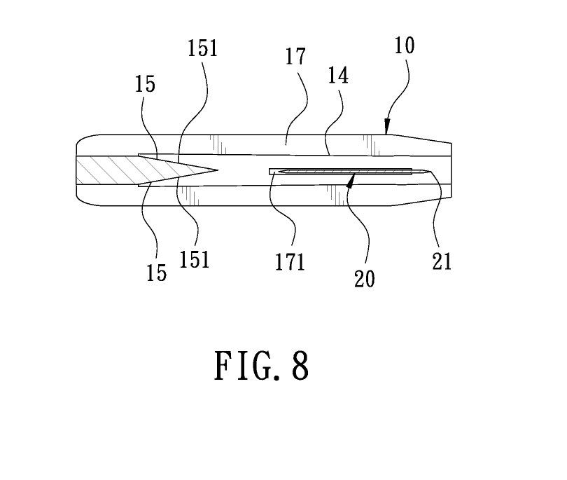

Referring to FIGS. 6, 7 and 8 which show various sectional views for the structure of the cutter for woven according to the present invention, the dimension of the second insert bore 22 is greater than the same of the first bore 163 but less than the same of the recess 162. The dimension of the third insert bore 31 is greater than the same of the first bore 163 and the second insert bore 22. The dimension of the third insert bore 31 is equal to the same of the recess 162. Therefore, the adjusting member 43 of the fixing member 40 can be assembled in turn through third insert bore 31 of the fixing plate cover 30 and the second insert bore 22 of the blade 20 to be stored in the recess 162. The edge of the blade 20 can be accurately adjusted to protrude into the cutting opening 14 with the fixing member 40.

Referring to FIG. 6 and as specified as above, since the first distance D1 is less than the second distance D2, therefore, portion of the blade 20 may positioned above the cutting slot 143 and protrude into the slot 171. Since the direction of the slot 171 is along the chamber bottom 161 of the accommodating chamber 16 so that the blade 20 will be firmly stored.

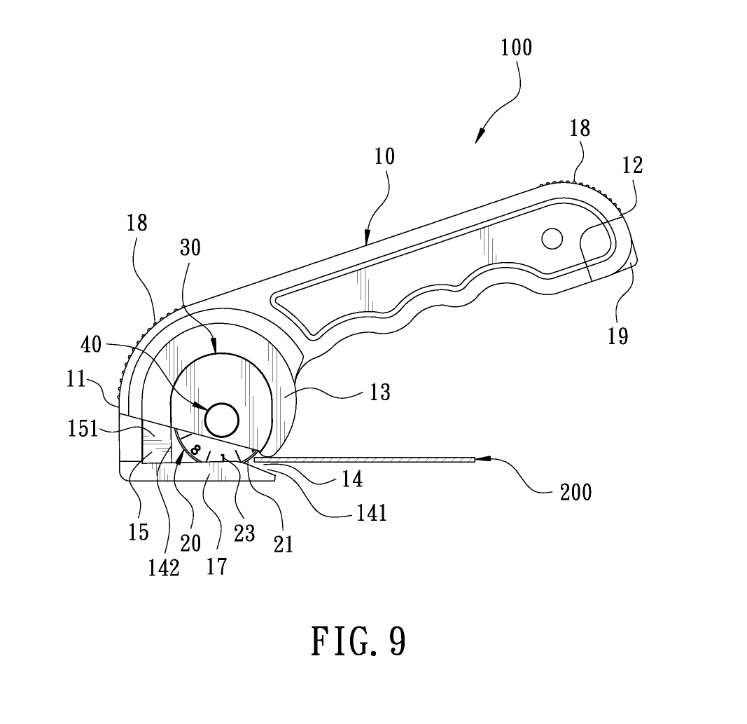

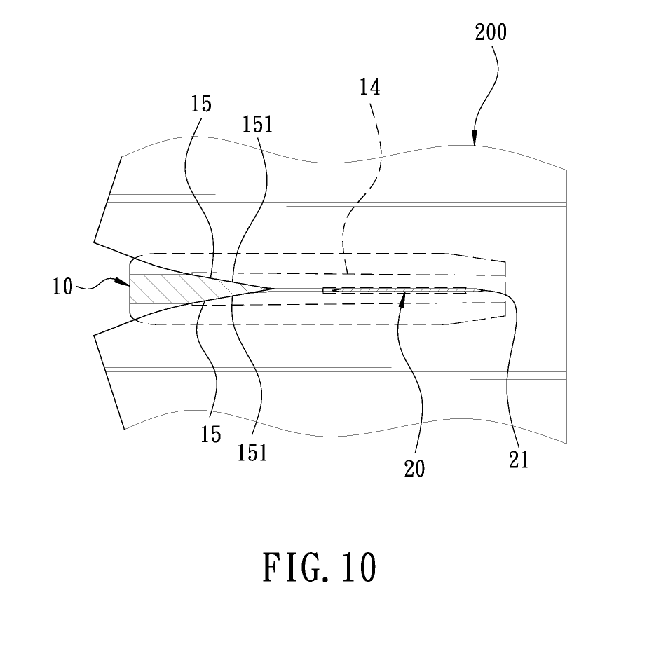

Referring to FIGS. 9 and 10, when user uses the cutter for the woven belt according to the present invention, he will hold the handle 10 to let the opening end 141 of the cutting opening 14 aligned to the woven belt 200. Then, one can push the cutter 100 to move toward the woven belt 200 to let the blade edge 21 of the blade 20 cut off the woven belt 200. Since the cutting opening 14 is provided in a direction from the second end 12 toward the first end 11, therefore, in a cutting process, a user's hand is moved at a place distant from the woven belt 200 preventing the woven belt 200 that has been cut apart from being hindered by the user's hand. Additionally, the cutting portion 13 has two sides respectively disposed with the guide groove 15. After cut operation, the cut portion of the woven belt 200 will be guided by the guide slopes 151 of the guide grooves 15 to be separated from the original woven belt. This will prevent the cut woven belts 200 from being accumulated at the sealed end 142 of the cutting opening 14. It is easily understood, the cutter 100 of the present invention can effectively cut off the woven belt 200 and, even if the width of the woven belt 200 is larger than the length of the cutting opening 14 of the cutter 100, the woven belt 200 having been cut apart will not be accumulated at the cutting opening 14. It will not hinder user's hand so as to facilitate the subsequent work of removing the woven belts 20 from the package.

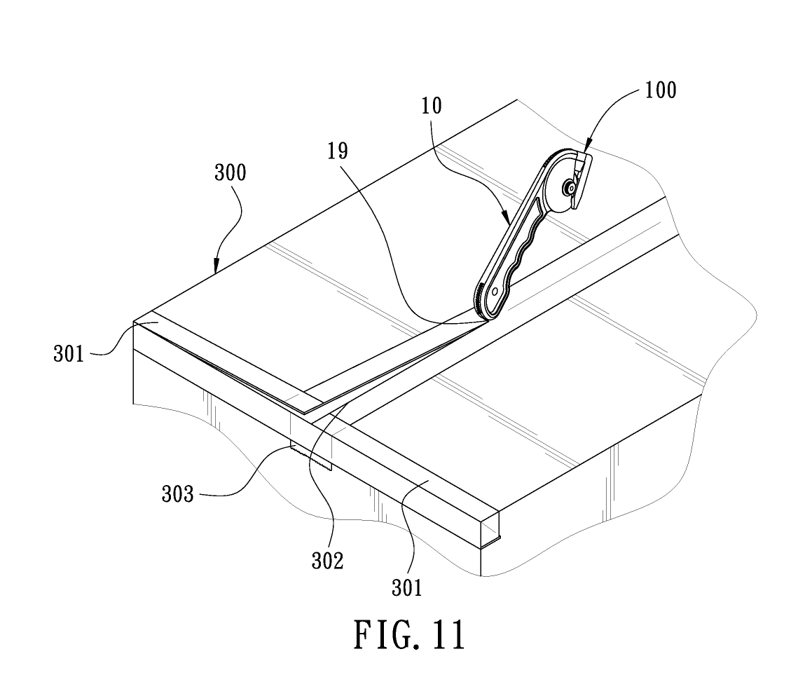

Referring to FIG. 11, aside from using woven belt 200 for fixing ordinary goods, cartons 300 are often used for packing of articles. The cutter 100 of this invention can also be used for unpacking cartons 300 with easiness. To unseal a carton 300, simply hold the cutter 100 reversely to have the pointed member 19 of the handle 10 aligned to and pierced through the joint portion 302 of two side plates 301 of the carton 300 to cut open the adhesive tape 303 for unsealing the carton 300. The cutter 100 may have other applications like this.

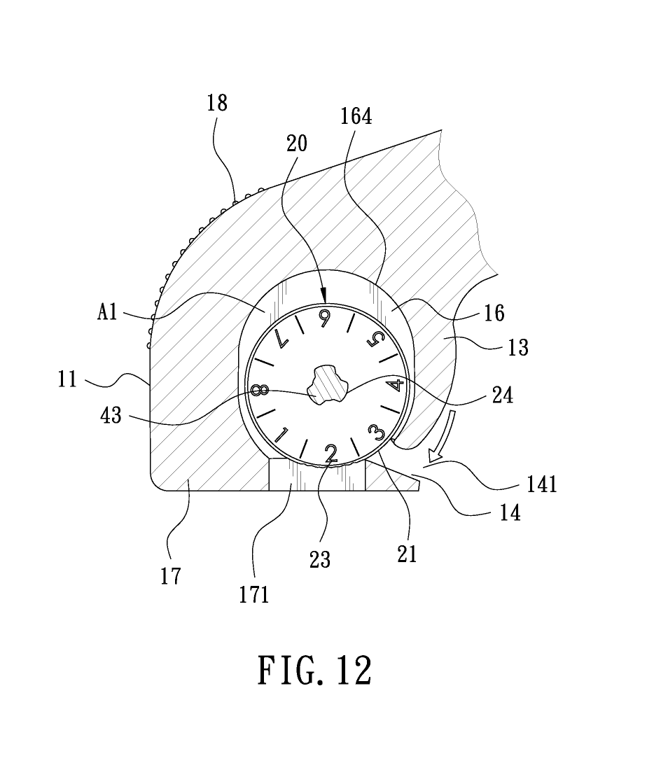

Referring to FIG. 12, the circumferential side of the blade 20 comprises blade edge 21 and a series of marks 23 are labelled. By adopting the adjusting member 43 of the fixing member 40 to fit the positioning member 24 of the blade 20, the fixing member 40 will rotate along with the blade 20. Therefore, when the blade 20 has been used for a certain period of time and the blade edge 21 becomes dull or produces wearing and chamfering, one may simply unscrew the fixing member 40 and rotate the blade 20 for an angle according to indication of the marks 23. Those portions of the blade edge 21 which are not yet damaged, can be continuously used for cutting off the woven belt 200 without the need to replace the blade 20 from time to time resulting a cost saving.

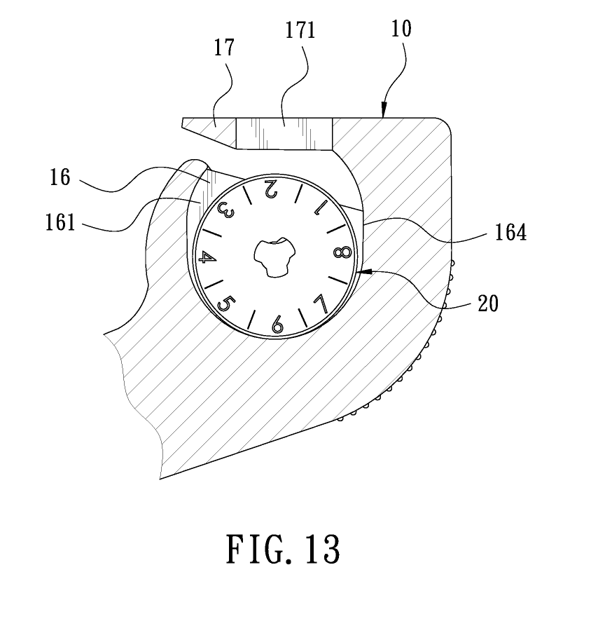

Referring to FIGS. 6 and 7, the chamber wall 164 of the accommodating chamber 16 is in elliptical shape. There is a half-moon shaped gap A1 formed between the chamber wall 164 of the accommodating chamber 16 and the blade 20. If the blade 20 is going to be replaced, please refer to FIG. 13, one can loosen the fixing member 40 and remove the fixing plate cover 30. Then turn the handle 10 to be up-side down, the blade 20 will drop automatically toward the half-moon gap A1 due to its own weight and gravity. Thus the exhausted blade can be littered. In a reverse procedure, a new blade can be dropped into the accommodating chamber 16 and turn the handle 10 as that shown in FIG. 5, the blade 20 will automatically with portion thereof sliding into the slot 171. One can then cover the fixing plate cover 30 and assemble the cutter with bolt 41 of the fixing member 40 to pass through second insert bore 22 of the blade 20 and the third insert bore 31 of the fixing plate cover 30. In addition to an effective blade change, user will not be necessary to hold the blade 20 all the time during the blade change. The safe security is much improved.

Another feature of this invention is that the handle 10 has its circumferential side provided with a plural of anti-skid bumps 18 at locations respectively close to the first end 11 and the second end 12 so as to achieve an excellent effect of slip prevention. This will enable a user to operate the cutter 100 conveniently whether he holds the handle 10 in a forward or reverse direction.

While the preferred embodiment of the invention has been described above, it will be recognized and understood that various modifications may be made therein and the appended claims are intended to cover all such modifications that may fall within the spirit and scope of the invention.

What is claimed is:

1. A cutter for woven belt comprising:
a handle having respectively a first end and a second end, said handle having a circumferential side bored with a cutting opening, said cutting opening provided in a direction from said second end toward said first end, said cutting opening formed with an open end and an opposite sealed end, said handle having a cutting slot with one side thereof formed into an accommodating chamber which having a first bore formed at the chamber bottom of said accommodating chamber;
a blade assembled within said handle and stored in said accommodating chamber, said blade having a second insert bore corresponding to said first bore of said accommodating chamber, a positioning member provided matching said second insert bore, said blade comprising a circumference edge with a series of mark labeled thereon and protruding into said cutting opening;
a fixing plate cover to be assemble at one side of said blade to cover said accommodating chamber, said fixing plate cover has a third insert bore matching with said first bore; and
a fixing member passing through said first bore, second insert bore and said third insert bore, said fixing member comprising a adjusting member matching with said positioning member so as to enable the said fixing member to rotate synchronized along with said blade;
thereby said blade can be adjusted as to its portion protruding into said cutting slot to improve the usage efficiency of the blade of the cutter.

2. A cutter for woven belt as claimed in claim 1 wherein said positioning member comprising a plurality of notches formed in the inner circumference of said second insert bore of said blade; said fixing member of said fixing plate cover comprising a bolt and a nut having said bolt passing through said first bore, second insert bore and said third insert bore; said bolt further comprising an adjusting member having a plurality of protrusions corresponding to said notches of said second insert bore.

3. A cutter for woven belt as claimed in claim 1 wherein said handle further comprising a base which has a slot parallel with a surface of said chamber bottom of said accommodating chamber, a first distance between said first bore and said cutting slot and a second distance between said first bore and said chamber wall of said accommodating chamber, said first distance is less than said second distance, said blade being disposed on said base and protruding in said slot of said base.

4. A cutter for woven belt as claimed in claim 3, wherein said accommodating chamber comprises a chamber wall in elliptical shape, said blade and said chamber wall forming a half-moon shaped gap.

5. A cutter for woven belt as claimed in claim 1, wherein said second insert bore having a dimension greater than the same of said first bore, said third insert bore having a dimension great than the same of said first bore and said second insert bore.

6. A cutter for woven belt as claimed in claim 5, wherein said chamber bottom of said accommodating chamber of said handle comprising a recess coaxially disposed with said first bore, said second insert bore having a dimension less than the same of said recess, said third insert bore having a dimension equal to the same of said recess.

7. A cutter for woven belt as claimed in claim 1, wherein said blade having a diameter greater than the length of said slot on said base.

8. A cutter for woven belt as claimed in claim 1, wherein said series of mark labeled on said blade are calibration carved lines.
